(19) United States
(12) Patent Application Publication
(10) Pub. No.: US 2019/0369742 A1
(43) Pub. Date: Dec. 5, 2019

(54) SYSTEM AND METHOD FOR SIMULATING AN INTERACTIVE IMMERSIVE REALITY ON AN ELECTRONIC DEVICE

(71) Applicant: Clipo, Inc., San Ramon, CA (US)

(72) Inventor: Faryar Ghazanfari, San Ramon, CA (US)

(73) Assignee: Clipo, Inc., San Ramon, CA (US)

(21) Appl. No.: 16/428,707

(22) Filed: May 31, 2019

Related U.S. Application Data
(60) Provisional application No. 62/678,925, filed on May 31, 2018.

(51) Int. Cl. G06F 3/01; G06K 9/66; G06K 9/62; G06T 19/00; G06K 9/00

(52) U.S. Cl. CPC G06F 3/017; G06K 9/66; G06K 9/6256; G06T 19/003; G06K 9/00355; G06F 3/011; G06K 9/6262; G06T 19/006

(57) ABSTRACT

Systems and methods for simulating interactive immersive reality environments on portable devices are disclosed. In one embodiment users can interact with virtual objects using hand gesture in front of a camera attached to the portable device. In one embodiment users can interact with virtual objects depending on their distance to the virtual objects in the virtual environment. In one embodiment movement of the portable device that is used to view the virtual environment is recorded by a server computer and a heat map is generated as an analytic tool.

### CROSS REFERENCE TO RELATED APPLICATIONS

This application claims priority from provisional application No. 62/678,925, Attorney Docket Number P105-1PUS, entitled “System and Method for Facilitating an Augmented Reality Portal” filed on 31 May 2018, the entirety of which is incorporated herein by reference for all purposes.

### BACKGROUND

The present application relates to simulation of virtual environments on a mobile device and a hand gesture recognition via the mobile device.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 shows an exemplary electronic portable device, according to one embodiment.

FIG. 2a shows an exemplary neural network, according to one embodiment.

FIG. 2b shows an exemplary neural network, according to one embodiment.

FIG. 3a shows an example of a hand gesture, according to one embodiment.

FIG. 3b shows an example of a hand gesture, according to one embodiment.

FIG. 4 shows an exemplary virtual environment, according to one embodiment.

FIG. 5 shows an exemplary virtual environment, according to one embodiment.

FIG. 6 shows an exemplary virtual environment, according to one embodiment.

FIG. 7 shows an exemplary virtual holographic assistant, according to one embodiment.

FIG. 8 shows an exemplary map of movement of a portable device in a virtual environment, according to one embodiment.

FIG. 9 shows an exemplary shopping system, according to one embodiment.

In the figures, like reference numerals refer to the same figure elements.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

Embodiments of the present invention provide a system and method for enabling simulation of immersive virtual environments on mobile devices and hand gesture recognition on the same mobile device to allow users to interact with the virtual environments and any virtual objects within the virtual environments using their hand. Other embodiments of the application are related to systems that can facilitate real-time changes of the immersive virtual environment using an easy to use web-based portal. Other embodiments of the application are related to gathering data and analytics from interaction of users within the immersive virtual environment.

Other embodiment of the invention are related to immersive virtual environments for online shopping on a mobile computing device. More specifically, a user can access a number of virtual shopping destinations (e.g., a car dealership, a department store, an apparel store of a particular brand, etc.), which can be displayed to the user via his mobile device as a sequence of computer-generated imagery (CGI) images. Once inside a virtual shopping destination, a user can “walk” around the store, browse displayed items from different angles by walking around the items, use his hand to pick up an item for examination, open a car door to exam the interior of the car, and interact with models or sales persons in the shopping destination.

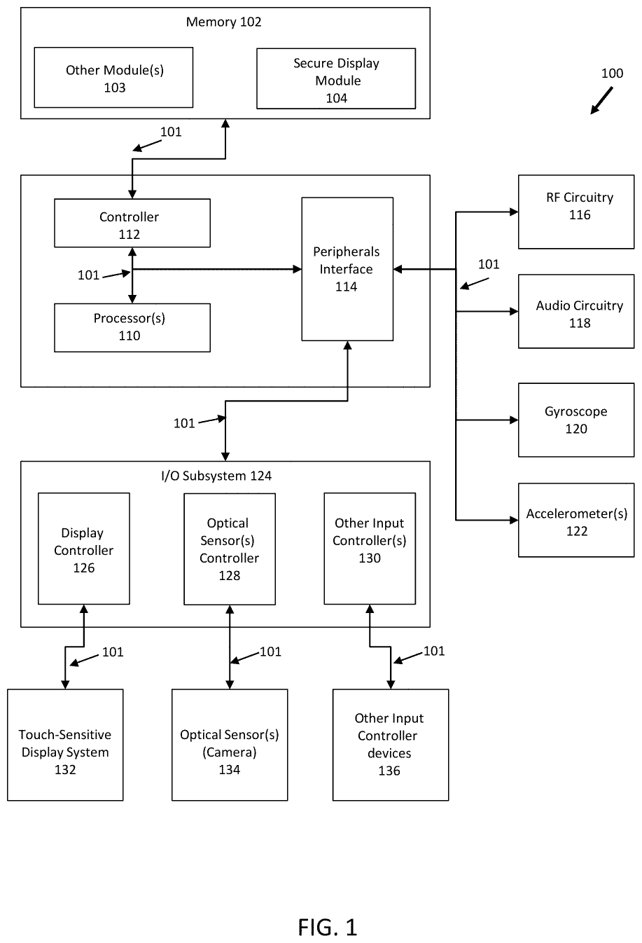

FIG. 1 illustrates an exemplary portable electronic device (e.g. a mobile phone). FIG. 1 is a block diagrams illustrating portable electronic devices 100 with touch-sensitive displays 132 in accordance with some embodiments. The touch-sensitive display 132 is sometimes called a “touch screen” for convenience, and may also be known as or called a touch-sensitive display system. The device 100 may include a memory 102 (which may include one or more computer readable storage mediums), a memory controller 112, one or more processing units (CPU's) 110, a peripherals interface 114, RF circuitry 116, audio circuitry 118 (which include a speaker and a microphone), gyroscope 120, Accelerometer(s) 122, an input/output (I/O) subsystem 124, other input or control devices 130, Optical sensor(s) controller 128, display controller 126, touch sensitive display system 132, optical sensor(s) (camera) 134 and other input control devices 136. These components may communicate over one or more communication buses or signal lines 101.

It should be appreciated that the device 100 is only one example of a portable electronic device 100, and that the device 100 may have more or fewer components than shown, may combine two or more components, or a may have a different configuration or arrangement of the components. The various components shown in FIG. 1 may be implemented in hardware, software or a combination of both hardware and software, including one or more signal processing and/or application specific integrated circuits.

Memory 102 may include high-speed random access memory and may also include non-volatile memory, such as one or more magnetic disk storage devices, flash memory devices, or other non-volatile solid-state memory devices. Access to memory 102 by other components of the device 100, such as the processor(s) 110 and the peripherals interface 114, may be controlled by the memory controller 112.

The peripherals interface 114 couples the input and output peripherals of the device to the processor(s) 110 and memory 102. The processors(s) 110 run or execute various software programs and/or sets of instructions stored in memory 102 to perform various functions for the device 100 and to process data.

The I/O subsystem 124 couples input/output peripherals on the device 100, such as the touch screen 132 and other input/control devices 136, to the peripherals interface 114. The I/O subsystem 126 may include a display controller 126 and one or more input controllers 130 for other input or control devices. The input controllers 160 may receive/send electrical signals from/to other input or control devices 116. The other input/control devices 130 may include physical buttons (e.g., push buttons, rocker buttons, etc.), dials, slider switches, joysticks, click wheels, and so forth. In some alternate embodiments, input controller(s) 130 may be coupled to any (or none) of the following: a keyboard, infrared port, USB port, and a pointer device such as a mouse.

The touch-sensitive touch screen 132 provides an input interface and an output interface between the device and a user. As explained above, the display controller 126 receives and/or sends electrical signals from/to the touch screen 132. The touch screen 132 displays visual output to the user. The visual output may include graphics, text, icons, video, and any combination thereof (collectively termed “graphics”, “electronic content”, and/or “electronic data”). In some embodiments, some or all of the visual output may correspond to user-interface objects, further details of which are described below.

A touch screen 132 has a touch-sensitive surface, sensor or set of sensors that accept input from the user based on haptic and/or tactile contact. The touch screen 132 and the display controller 126 (along with any associated modules and/or sets of instructions in memory 102) detect contact (and any movement or breaking of the contact) on the touch screen 132 and convert the detected contact into interaction with user-interface objects (e.g., one or more soft keys, icons, web pages or images) that are displayed on the touch screen. In an exemplary embodiment, a point of contact between a touch screen 132 and the user corresponds to a finger of the user.

The touch screen 132 may use LCD (liquid crystal display) technology, or LPD (light emitting polymer display) technology, although other display technologies may be used in other embodiments. The touch screen 132 and the display controller 126 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen 132.

In some embodiments, the software components stored in memory 102 may include a secure display module 104 which allows viewing electronic contents such as text, image and video is a secure fashion. Memory 102 may include other modules that store various other control logics such as an operating system, a communication module (or set of instructions), a contact/motion module (or set of instructions), a graphics module (or set of instructions), a text input module (or set of instructions), a Global Positioning System (GPS) module (or set of instructions), and applications (or set of instructions).

The operating system (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

In some embodiments, portable electronic device 100 may be a pair of wearable glasses where instead of display 132 a pair of glasses are used to reflect digital information in front of user's eyes. Such devices also known as “augmented reality” or “mixed reality” glasses may have the same set of components as shown in FIG. 1 as embedded hardware, or several of the components may be in another mobile device such as a mobile phone and the wearable unit may communicate with the mobile device via a communication link (such as Bluetooth) to transfer imagery data that can come from a camera installed on the wearable device to a processor on a mobile device and receive data that are processed by the processor to display on the lenses of the wearable device. Therefore, those skilled in the art will appreciate that the component shown in FIG. 1 may be spread between one or more physical devices and they may work in concert through one or more communication link to conduct the processes described in this application.

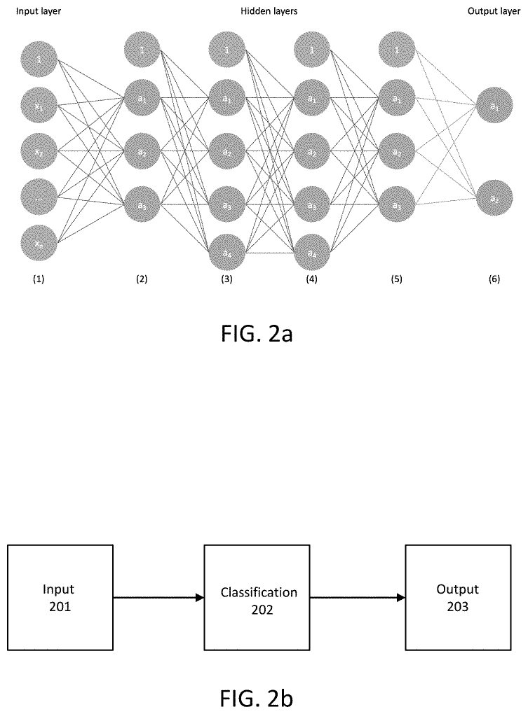

Attention is now directed to FIG. 2a showing a high-level illustration of a convolutional neural network (CNN, or NN for short). In the field of Artificial Intelligence, such networks are used for analysis and classification of images. Generally, a NN is “trained” by gathering and classifying a series of samples (training data), the NN is then put through a process of digesting the samples for each classification. Once a NN is trained, it can be fed an input, if the input has similarity within a degree to any of the sample data that was used during the training process, the NN then “classifies” the input and outputs a classification result. In the context of imagery analysis, for example, if a NN is trained to classify between images of cats and dogs, first, during the training process, a series of cat images in various positions, lighting situation and physical variations are put into a training set labeled as “cat”. A similar process is done for a series of images of dogs. The NN then processes the samples and at the end “learns” to associate images of cats as cats and images of dogs as dogs. This “classification” works based on the assumption that the image that is inputted to the NN resembles to some extent any of the sample images that was originally used to train the NN. During the training process, the NN forms a series of “layers” also called “hidden layers” which record a series of characteristics of the sample training data. As the input is fed into the NN, the image goes through these layers and each time various aspect of the image is analyzed by the NN and at the end a determination is made as to whether the image could be classified as any of the labels that the NN is trained to identify. To simplicity, FIG. 2b shows the CNN showing in FIG. 1 as three main components of input 201, classification 202 which is meant to encapsulate all the layers of the CNN and the output 203.

The actual inner workings of a CNN has more intricacies and complexities, however, the provided description is sufficient for those skilled in the art to appreciate the novel approach that will be explained in the present application to detect a number of hand gestures. In a training process a series of hand gestures are recorded and fed into a CNN for training, each of the series of hand gestures are labeled during the training process. Thereafter when a hand gesture is shown in front of a camera and the resulted imagery is fed into a CNN, if the CNN is able to classify those images (i.e. the hand gesture depicted in those images) it then classifies them as a label.

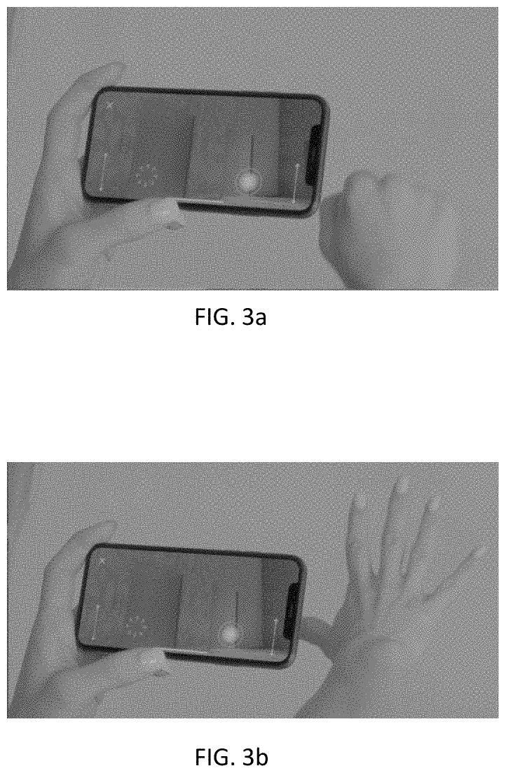

FIGS. 3a and 3b show an exemplary hand gesture. FIG. 3a shows a hand coming toward a camera of a mobile device and then it is opened (FIG. 3b). During this movement, the camera takes a number of images and feeds them into a CNN, when the CNN “sees” the open palm (assuming such hand gesture was used during the training process as a classification), it classifies it as open palm, thereafter, as a result of this classification an action can be triggered. For example, in the context of the present applications, such a trigger can be used to change a state of a virtual object such as its location, size or moving the object.

In one embodiment, a CNN can be used to determine the location of a hand and its shape in a 3D space. This requires a sophisticated training process where a sufficient number of samples are gathered and an object tracking algorithm is also used to track the hand and then combined with an estimated distance that is determined by an object tracking algorithm, an estimated distance is also determined by the CNN as a result of the classification, this can be achieved by feeding samples to the CNN during the training process as various distances and labeling then as such. Therefore, if enough samples are used, the CNN will be able to classify the hand gesture and also classify its distance from the camera. This novel technique can be used advantageously in the context of virtual reality, augmented reality and mixed reality applications to allow a user to interact with virtual objects with their bare hands.

Use of depth tracking sensors in addition to the camera that inputs the recorded imagery to the CNN can be helpful to determine where the hand is in a 3D space, however, the need for depth sensor can be eliminated if the CNN is trained to both classify the image and the distance of the hand shown in the image.

The hand gesture recognition described above may be used in a novel virtual simulation technique hereinafter called Interactive Immersive Reality (IIR). IIR can be used to simulate immersive environment on mobile devices such as phones, tablets, AR glasses, virtual headsets, etc. and allow users to interact with the virtual objects with their hand.

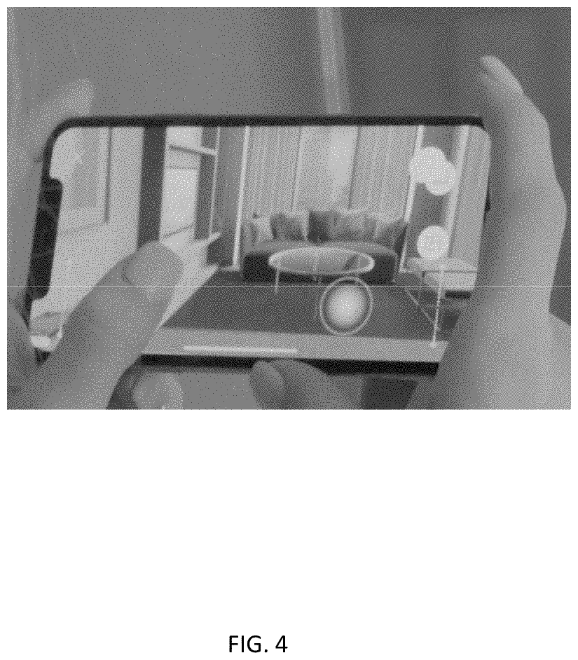

In some embodiments, a virtual shopping environment can be presented to the user on the display (e.g., a touchscreen) of a mobile device as an augmented reality, virtual reality or interactive immersive reality. FIG. 4 shows an exemplary virtual environment, according to one embodiment. As the user maneuvers in the physical world, such as turning the direction of the phone or walking around with the phone in her hand, the scenery within the virtual environment can change accordingly to create the effect of the user being immersed in the virtual environment. More specifically, the mobile device now displays to the user surroundings of the virtual environment (e.g., the inside of a car dealership, an apartment, a clothing store, art gallery, etc.) and the displayed content can be updated in real time based on the user's movements in the physical world. For example, when the user lift up the mobile device and his head to view the display from underneath, CGI images of the sky or ceiling can be displayed. This can provide the user the sensation of looking upward in the virtual shopping destination. Similarly, as the user walking around in the physical world (e.g., forward, backward, turn, etc.) the displayed scenery updates accordingly, giving the user the sensation of walking around inside the shopping destination.

In addition to allowing the user to move (e.g., walk or run) in the augmented world by moving in the physical world, in some embodiments, the user can also perform “virtual movement” in the virtual environment by interacting with game-like interface and buttons on the touchscreen. This feature allows the user to navigate an infinitely large augmented world while remain in the space-limited physical world.

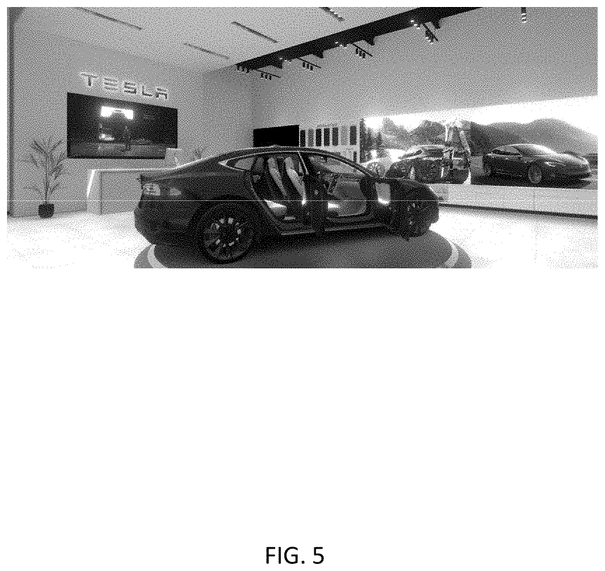

In some embodiments, as shown in FIG. 5, various real-world objects can be embedded in the augmented/virtual world, such as pictures or videos. For example, the augmented world may include a picture frame or a TV hanging on a wall. The picture frame can display a real-world picture, not a CGI image, and the virtual TV can play a video pre-recorded in the real world. In a further embodiment, the instant real-world environment recorded by a camera on the mobile device can be projected onto the virtual TV.

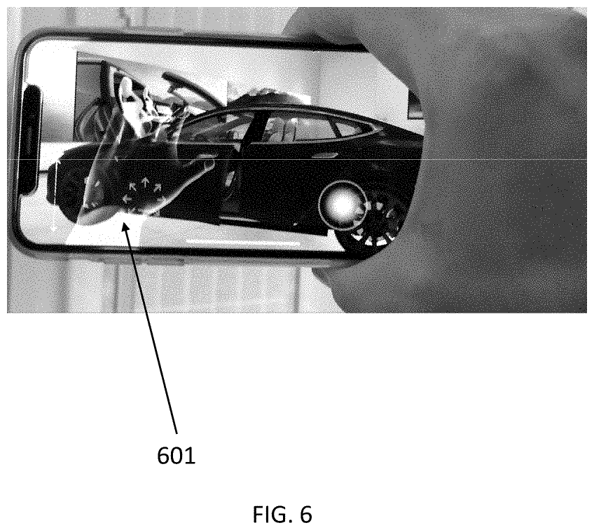

In some embodiments, a user can use his hand movements or hand gestures in the real world to maneuver objects in the augmented world. For example, a user can use his hand to open and close car doors in the augmented world. FIG. 6 shows a user opening car doors in the augmented world, according to one embodiment. Note that the user's hand is not physically shown in the virtual environment scene. This is because conventional VR rendering always assigns higher priority to virtual images than the real world image, thus causing the real hand to be seen as “going through” the car door. To prevent such an effect, in some embodiments, the real hand can be shown using occlusion in virtual image rendering as a shadow 601 overlaying the virtual object. Other examples can include a user using his hand to pick up a virtual object in the augmented world and maneuver the virtual object by turning it in different directions as if he is examining a real object in a store in the physical world. Various machine learning techniques can be used by the system to detect and recognize a user's hand movements as described above. In some embodiments, the system can train a convolution neural network (CNN) to recognize users' hand gesture and/or movement.

As the user moves around inside a virtual shopping destination, the scene displayed by the mobile device can change accordingly, simulating the effect of the user walking around in a shopping destination of the physical world. For example, new objects can be brought into view or existing objects can become larger when the user “walks” to be closer to the objects. In the example of the user “visiting” a virtual car dealership, the user can also “open” the doors of a car to view the interior of the car. The user can even “enter” the car, “sit” on the driver's seat, and “look” around inside the car. When the user is “inside” the virtual car, CGI images of the interior of the car can be displayed accordingly. Note that the CGI images can be generated using a novel light-simulation algorithm such that they appear to be realistic. More specifically, light reflections and shadows can be accurately simulated in rendered images, thus creating a realistic effect for the user.

In addition to the accurate simulation of light reflections and shadows, volumetric photogrammetry techniques can also be used to create interactive virtual shopping destinations that can provide realistic experience to users. For example, using volumetric capture techniques and photogrammetry image processing, not only the shape of an object but also its texture (e.g., the texture of a clothing item or car upholstery) can be vividly displayed to the user. In some embodiments, computer rendered images of a virtual shopping destination can be displayed using high definition (e.g., 4K).

Because the virtual-shopping system is typically run on a mobile computing device with limited resources, and because CGI image rendering often can require a large amount of resources, efficient resource management can be important. In some embodiments, a dynamic asset-management technique can be used when rendering the CGI images. More specifically, during operation, the system can dynamically adjust resolutions of different portions of the displayed images based on the viewing point and angle of the user. Objects that are in the field of view of the user can be rendered at a high resolution, whereas objects that are in the background may be rendered at a low resolution, thus effectively reducing the total amount of required resources needed for rendering the scene. As the user “moves” in the virtual environment, his field of view or areas of interest can change. In response, the system dynamically measures the user's position to determine his field of view, identifies the focus point of the user's vision (e.g., by performing gaze tracking), and renders different portions of the virtual environment accordingly. In areas closer to the focus point of the user's vision (e.g., areas where the user is observing), the rendering resolution can be much higher than that of the far away or background areas.

Using the virtual car dealership as an example, when the user “enters” a car, the interior of the car (e.g., the display panels, the upholsteries, etc.) can be rendered using a high resolution in order to create a realistic effect. Meanwhile, other parts of the car (e.g., its exterior) or other parts of the dealership that appear in the rendered image can be rendered at a low resolution. Note that, because the user is most likely to concentrate his attention to the portion of the rendered image that is in the center of his field of view, rendering other parts of the image at a lower resolution does not affect the user's impression of the image. On the other hand, when the user “steps out” of the car, the interior of the car is no longer at the center of the user's field of view, as a result, the system can now render the interior of the car at a lower resolution; whereas the exterior of the car may become the focus point of the user's vision, and the system needs to render the exterior of the car at a higher resolution in order to continue to provide the user realistic virtual experiences. The switching between low and high rendering resolutions can appear to the user in a seamless way and does not change the user's perception of the virtual environment.

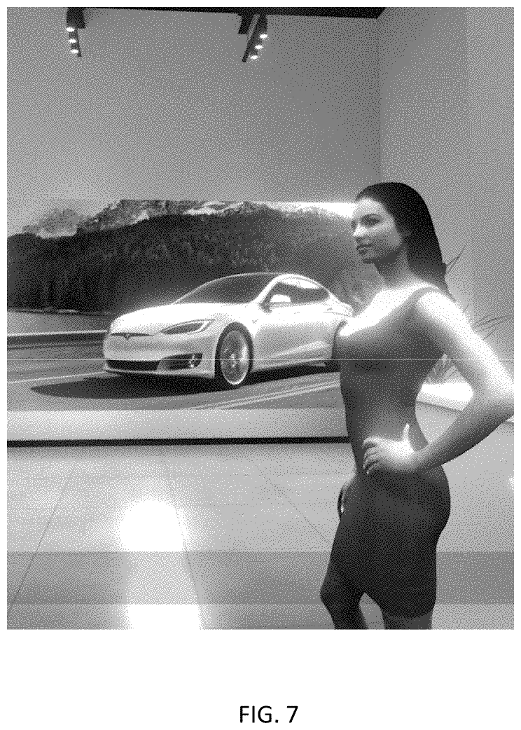

In some embodiments, the virtual environment can be interactive. More specifically, an artificial intelligence (AI) character, as shown in FIG. 7, can be created in the virtual environment to interact with the user. For example, an AI sales person can be embedded in a virtual shopping destination (e.g., virtual car dealership). Using various AI technologies (e.g., CNN, speech recognition, etc.), the AI character can have a meaningful conversation with the user (e.g., answering questions or introducing products). In addition to chatting, the AI character may also perform actions in response to the user's actions or commands, thus providing the user with a shopping experience similar to the one in the physical world. For example, a car salesman may “follow” the user around as the user “walks” in the virtual car dealership; or a clothing model may turn or move (e.g., raising an arm) in response to the user's verbal request. In some embodiments, the sales person that appears as a holographic object with the virtual environment, may be controlled remotely by a live person, such that the user communicates through the holographic character with a live sales person at a remote location.

In some embodiments, the interactive features can be turned on based on the user's proximity to a character or a product. In other words, a change in the state of the virtual object can occur when the distance from where the digital display is located to where the virtual object appears on the digital display reaches a predetermined number. More specifically, the system can determine a distance between the user's position in the virtual environment and an AI character or a displayed product. If the distance is below a predetermined threshold, the system can “wake up” the AI character or display information associated with the product. In some embodiments, a virtual barrier can be established around an item (AI character or product) in the virtual environment; if a user's movements (e.g., movements in the physical world or “augmented” walks) cause the user to break the virtual or artificial barrier of the item, the interactive feature of the item can be turned on. If the virtual item is a character (e.g., a clothing model), it can start to converse with the user or move. For example, the clothing model may turn to allow the user to view the clothing item from different angles. Moreover, the clothing model may turn and change the color of the clothing item. If the item is a displayed product, the system can overlay information (e.g., composition, make, price, etc.) associated with the product on the rendered image of the virtual environment. FIG. 4 shows an example of proximity-based interaction, according to one embodiment. In the left drawing, the model is far away from the user based on the user's position in the augmented world. In the right drawing, the user has approached the model, breaking the artificial barrier around the model. As a result, the model becomes animated (e.g., turns around toward the user) and price information (shown inside the dashed circle) associated with the clothing item is displayed on the screen.

In some embodiments, the virtual environment can interact with the physical world in such a way that images or live videos of the physical world can be displayed in the virtual environment. As discussed previously, live images or videos of the physical world can be projected onto a virtual display (e.g., a TV screen) in the augmented world. For example, a TV in the augmented environment can play a pre-recorded video or a live video stream of the physical world.

The virtual environment can also include interactive walls, which can simulate digital touch-screen displays that allow a user to input commands using hand gesture (e.g., clicking or finger-wiping). For example, a wall in a virtual car dealership as shown in FIG. 5, can display images of many cars, and a user can tap an image on the wall to make a selection, turning the selected car to a virtual object displayed in the car dealership. In some embodiments, the interactive walls can also be turned on based on user proximity. In such a scenario, a wall in the augmented world may be rendered as an ordinary wall originally; as the user approaches the wall in the augmented world, its turns into an interactive display.

In some embodiments, not all characters are generated by computers. In some embodiments, a number of virtual characters may be created using images of real people. For example, certain clothing models can be created using pre-recorded images of human models wearing particular pieces of apparels. More specifically, the system can scan (e.g., taking images) a real human model wearing the clothing item in motion using volumetric photogrammetry. Using the scanned results, the system can create a realistic and interactive character in the augmented world. However, images captured using volumetric photogrammetry may sometimes not be able to provide sufficient details in hard-to-see areas. In some embodiments, CGI technologies can be combined with volumetric photogrammetry. More specifically, CGI can be used to generate objects that were not captured in detail by volumetric photogrammetry techniques, and the CGI-generated objects can be stitched together with images captured using volumetric photogrammetry techniques during rendering.

In one embodiment, the price information of the closing item is shown on the touchscreen. In some embodiments, the user can make a purchase by clicking a displayed shopping cart symbol, which can provide a link to a third-party shopping system. More specifically, the third-party shopping system can maintain a shopping cart that tracks the user's purchases from multiple virtual shopping destinations (e.g., from multiple apparel stores). This way, the system does not need to track the user's purchases across the multiple shopping destinations, but hands off this responsibility to the third-party shopping system. In some embodiments, each time a user places an item in the shopping cart, a particular link to the selected item can be sent to the third-party shopping system, allowing the shopping system to obtain detailed information (e.g., item description and price) associated with the selected item. For example, a user may select a shirt from a first virtual store and a pair of pants from a second virtual store. Instead of having to pay at each store separately, the user can do a final checkout at a single location. In addition to providing convenience to the user, this also allows for scaling up of the system. The system can add more virtual shopping destinations (e.g., virtual stores) without the need for establishing additional payment systems.

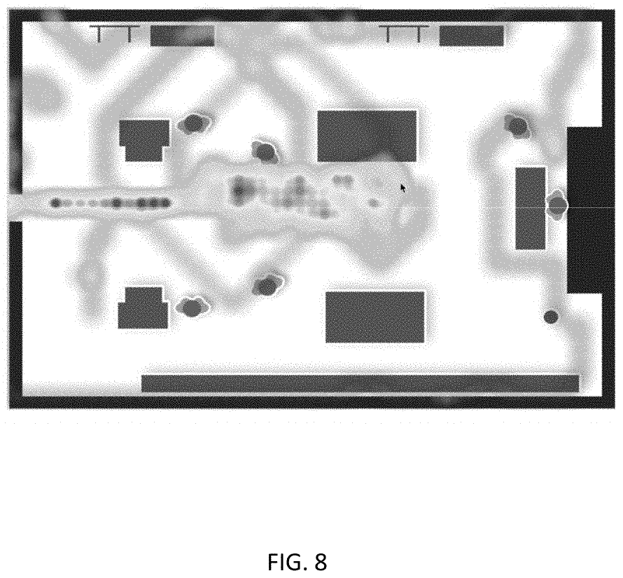

In addition to be interactive with users, the virtual shopping system can also collect user behavior data and provide various analytics to merchants. For example, as the user “walks” around a shopping destination, the virtual shopping system can track the user's movements and determine the user's movement pattern (e.g., route taken, amount of time spent at a particular display, etc.). Such data collection can be similar to the one performed in a physical store. FIG. 8 shows a two-dimensional het map of a virtual environment where the virtual foot traffic of users is captured and graphed with various colors to denote high traffic and low traffic paths. The “virtual foot traffic” is technically the movement of the portable electronic device within the immersive virtual environment. In addition, using gaze tracking on a portable electronic device such as a phone, user's gaze can also be tracked more accurately, for providing analytics on the user's attention span. Moreover, the system can also detect the user's facial expression while he is looking at a particular displayed item. All these analytics about the users' shopping behavior can be sent to merchants, thus allowing the merchants to make improvement to their virtual store (e.g., the layout) or perform market analysis.

In some embodiments, geotagging can also be used to improve the user's shopping experience. More specifically, the augmented shopping destination displayed to the user can be configured in such a way that corresponds to the current geographic location of the user. Note that the geographic location of the user can be obtained, with the user's permission, using various location-tracking techniques. For example, the system may access the GPS located on the mobile device to obtain the user's location. A store of a particular clothing brand may have different appearances at different geographic locations (e.g., at different part of a country or at different countries). To provide the user with a more realistic shopping experience, it is desirable to match the appearance of the displayed virtual store to the physical store that the user is most likely to visit (e.g., a local store). For example, the language (written or spoken) and/or currency used in the virtual store can match those used in a corresponding local physical store, or the decoration and/or layout of the virtual store can match that of the local physical store. In addition to location-based store configuration, in some embodiments, the configuration of the virtual store may also be time-dependent. For example, depending on the time of the day, the virtual store may have natural or artificial lighting; or depending on the time of the year, the virtual store may have seasonal decoration (e.g., Christmas themed decoration during Christmas season). This can provide the user with a more realistic shopping experience. Other than geotagging, additional AI engines may also be implemented to collect demographic data associated with the user (e.g., age, gender, race, etc.). The system can then configure a displayed store based on the user's demographic information to increase its appealing factor. Moreover, the system may configure its navigation interface based on the user's demographic information. For example, if the user is a millennial, trendy stores appealing to the younger generation may be placed on the top of the navigation page of the system.

Other than user interaction, in some embodiments, the backend of the system may also provide the virtual store designer or the merchant with an interactive interface that allows the merchant to access customers of the virtual store in real time. In one embodiment, the merchant may be able to send customized push notifications (e.g., coupons or promotion sales) to customers. Such push notifications can sometimes bypass the virtual shopping system, given that they abide a number of basic rules (e.g., timing). Moreover, a merchant can also perform market testing (e.g., A/B testing) using the virtual shopping system. The merchant can present testing samples to customers in its virtual store, and the virtual system can provide analytics (e.g., duration of gaze, facial expression, etc.) back to the merchant in response to the testing samples.

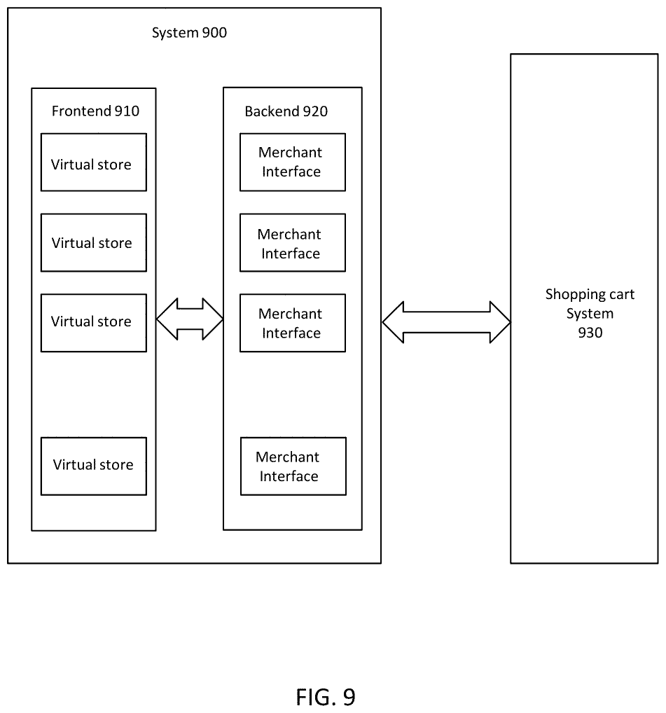

FIG. 9 shows exemplary system architecture, according to one embodiment. System 900 can include frontend layer 910 and backend layer 920. Frontend layer 910 can include a number of virtual store modules for displaying virtual shopping destinations. In one embodiment, each virtual store can be displayed on a mobile device. Backend layer 920 can include a number of interfacing module for interfacing with corresponding merchants. In one embodiment, the merchant interfaces can be server computers that remotely communicate with mobile devices that display the virtual stores. In addition to the merchants, the interface modules in backend layer 920 can also interface with an external, remote shopping-cart system 930. As one can see from FIG. 9, all virtual stores can be linked to shopping-cart module 930.

In some embodiments, deep linking can also be implemented to provide consumers with direct access to a particular virtual store form other platforms (e.g., social network websites, the merchant's own website, etc.). Consumers do not need to navigate through the virtual shopping system (which may host thousands of virtual stores) in order to go to a particular virtual store of interest.

In some embodiments, a search engine can be implemented within the virtual shopping system. In other words, each and every item within the virtual shopping system can be searchable, and the user can use voice or other input mechanism to initialize a search.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

What is claimed is:

1. A system comprising:
a processor;
a camera coupled to the processor, wherein the camera is capable of recording a series of digital images;
a digital display coupled to the processor; and
a memory coupled to the processor; wherein the memory is capable of storing digital data and computer readable instructions that can be processed by the processor; and wherein the memory contains computer readable instructions to:
display a virtual object on the digital display;
receive from the camera a series of images depicting one or more hand gestures shown in front of the camera;
input the series of images into a neural network capable of classifying an image from the series of images; and
change a state of the virtual object depending on a type of a hand gesture from the one or more hand gestures, wherein the type of the hand gesture is determined by the neural network after classification of the series of images.

2. The system of claim 1, wherein change the state of the virtual object includes modifying the appearance of the virtual object on the digital display.

3. The system of claim 1, wherein the change of the state of the virtual object includes modifying the location of the virtual object on the display.

4. The system of claim 1, wherein the change of the state of the virtual object includes modifying the size of the virtual object on the digital display.

5. The system of claim 1, wherein the change of state of virtual object includes outputting audible sound from a speaker coupled to the processor.

6. The system of claim 1, wherein the system is a handheld device.

7. The system of claim 1, wherein the system is a pair of glasses situated in front of human eyes.

8. A system comprising:
a processor;
a camera coupled to the processor, wherein the camera is capable of recording a series of digital images;
a digital display coupled to the processor;
a gyroscope coupled to the digital display, wherein the gyroscope determines the pitch, roll and yaw of the system, and
a memory coupled to the processor; wherein the memory is capable of storing digital data and computer readable instructions that can be processed by the processor; and wherein the memory contains computer readable instructions to:
display a virtual object on the digital display wherein the view of the virtual object changes according to changes of pitch, roll and yaw of the system;
determine a distance from where the digital display is located to where the virtual object appears on the digital display; and
change a state of the virtual object when the distance from where the digital display is located to where the virtual object appears on the digital display reaches a predetermined number.

9. The system of claim 8, wherein the virtual object is shown inside a virtual environment displayed on the digital display.

10. The system of claim 8, wherein the view of the virtual environment changes according to changes of pitch, roll and yaw of the system.

11. The system of claim 8, wherein the system is a handheld device.

12. The system of claim 8, wherein the system is a pair of glasses situated in front of human eyes.

13. A system comprising:
a server computer including
a first processor;
a first memory coupled to the first processor; wherein the first memory is capable of storing digital data and computer readable instructions that can be processed by the first processor; and wherein the memory contains first set of computer readable instructions to:
communicate with a portable electronic device comprising a second processor, a camera, a digital display coupled to the camera, and a second memory containing second set of computer readable instructions configured to connect the portable electronic device to the server computer, and wherein the portable electronic device is capable of simulating an immersive virtual environment on the digital display and send a set of virtual coordinates within the immersive virtual environment to the server computer;
receive from the portable electronic device the set of virtual coordinates, and
generate a two-dimensional map of movement of the portable electronic device within the immersive virtual environment.

14. The system of claim 13, wherein the immersive virtual environment is a store containing one or more virtual objects representing one or more corresponding physical objects.

15. The system of claim 13, wherein the first set of computer readable instructions are adapted to change a one or more characteristic of the immersive virtual environment.

16. The system of claim 15, wherein the one or more characteristics of the immersive virtual environment include adding one or more virtual objects to the immersive virtual environment.

17. The system of claim 15, wherein the one or more characteristics of the immersive virtual environment include adding one or more pictures to the immersive virtual environment.

18. The system of claim 15, wherein the one or more characteristics of the immersive virtual environment include adding one or more videos to the immersive virtual environment.

19. The system of claim 13, wherein the first set of computer readable instructions is configured to receive from the portable electronic device one or more product identifiers wherein the product identifiers identify one or more items in a database.

20. The system of claim 13, wherein portable electronic device simulates the immersive virtual environment depending on the location of the portable electronic device, and wherein one or more characteristics of the immersive virtual environment change depending on the location of the portable electronic device.
